(19) United States
(12) Patent Application Publication
(10) Pub. No.: US 2011/0032728 A1
(43) Pub. Date: Feb. 10, 2011

(54) Light Source Device, and Display Apparatus Provided with Such Light Source Device

(75) Inventors: Yasunari Nagata, Kirishima-shi (JP); Masanori Kurita, Higashiomi-shi (JP); Yoshio Miyazaki, Kirishima-shi (JP)

Correspondence Address: DLA PIPER US LLP, 1999 AVENUE OF THE STARS, SUITE 400, LOS ANGELES, CA, 90067-6023, US

(73) Assignee: KYOCERA CORPORATION, Kyoto-shi, Kyoto (JP)

(21) Appl. No.: 12/936,378

(22) PCT Filed: Apr. 6, 2009
(86) PCT No.: PCT/JP2009/057079

§ 371 Date: Oct. 4, 2010

(30) Foreign Application Priority Data
Apr. 4, 2008 (JP) 2008-098528

(51) Int. Cl. F21V 7/22

(52) U.S. Cl. 362/606

(57) ABSTRACT

A light source device includes a first light source group, a second light source group, a light guide body, and a light diffusion body. The light guide body includes a high light distribution region and a low light distribution region generated by the respective light sources of the second light source group. The high light distribution region includes a plurality of first portions. The low light distribution region includes a second portion between the first portions and a third portion. The presence ratio of the light diffusion body 30 in the third portion is greater than that in the first portion. The quantity of light incident in the light guide body from an end light source located so as to correspond to the third portion is smaller than that from a center light source arranged so as to correspond to the second portion.

### TECHNICAL FIELD

The invention relates to a light source device that irradiates light, which is incident from a plurality of light source groups, to a target portion through a light guide body, and a display apparatus provided with such a light source device.

### BACKGROUND ART

A light source device including a plurality of light source groups has been proposed as a light source device used for a liquid crystal display device, from the viewpoint of the increase in display information amount, etc. (e.g., Patent Document 1). A light source device used for a liquid crystal display device disclosed in the Patent Document 1 includes a first light source group having a plurality of red light-emitting diodes, a second light source group having a plurality of green light-emitting diodes, and a resin (corresponding to a light guide body) that emits light upon receipt of the light from the first light source group or the second light source group. Each of the green light-emitting diodes in the second light source group is arranged so as not to be overlapped with each of the red light-emitting diodes in the first light source group as viewed in plane. In this light source, brightness unevenness in the vicinity of the respective light-emitting diodes tends to increase due to the arrangement of the respective red light-emitting diodes and the green light-emitting diodes. Therefore, a technique of reducing such brightness unevenness has conventionally been developed. Various techniques are described in Patent Documents 2 and 3.

Prior Art documents

Patent Documents

Patent document 1: Japanese Laid-open Patent Publication No. 4-136623

Patent document 2: Japanese Laid-open Patent Publication No. 11-353920

Patent document 3: Japanese Laid-open Patent Publication No. 2005-183124

### DISCLOSURE OF INVENTION

### Problem to be Solved by the Invention

However, in the light source devices disclosed in the publications described above, light sources that emit light of different colors are arranged in the thickness direction of the light guide body in order to reduce the brightness unevenness in displaying each color. Therefore, the thickness of the light guide body increases, so that it is difficult to downsize the device.

The invention is accomplished in view of the above-mentioned circumstance, and aims to provide a light source device that allows reducing the brightness unevenness in the light emission based upon a plurality of light source groups and that reducing the size of the device, and a display apparatus provided with such a light source device.

### Means for Solving Problem

In order to solve the above mentioned problem and to achieve the above mentioned purpose, a light source device according to one embodiment of the invention includes a first light source group comprising a plurality of first light sources; a second light source group comprising a plurality of second light sources, each of which is located between the first light sources of the first light source group; a light guide body arranged so as to correspond to the first light sources of the first light source group and second light sources of the second light source group; and a light diffusion body that diffuses light incident through the light guide body, When a range of an angle where brightness of light emitted from the respective second light sources is not less than a reference value is defined as a high light distribution angle range of the respective second light sources, and a range of an angle where the brightness of light emitted from the respective second light sources is smaller than the reference value is defined as a low light distribution angle range of the second light sources, when, in the light guide body, a region where light emitted from the respective second light sources with an angle within the high light distribution angle range is incident is defined as a high light distribution region of the respective second light sources, and a region other than the high light distribution region and where light emitted from the respective second light sources with an angle within the low light distribution angle range is incident is defined as a low light distribution region of the respective second light sources, and when a border between the high light distribution region and the low light distribution region of each of the second light sources is defined as a borderline, and a line linking the intersections of the borderlines by the adjacent second light sources is defined as a reference line, the light guide body includes: a plurality of first portions contained in the high light distribution region and located at a side close to the second light source than the reference line; a second portion contained in the low light distribution region and located between the first portions; and a third portion contained in the low light distribution region, being other than the first and second portions, and having a presence ratio of the light diffusion body greater than the presence ratio of the light diffusion body in the first portion. Each of the first light sources is arranged so as to correspond to the second and the third portions of the light guide body, and the quantity of light incident in the light guide body from the first light source arranged so as to correspond to the third portion is smaller than the quantity of light incident in the light guide body from the first light source arranged so as to correspond to the second portion of the light guide body.

Further, a light source device according to one embodiment of the invention includes: a first light source group comprising the first light sources; a second light source group comprising the second light sources, each of which is located between the first light sources of the first light source group; a light guide body arranged so as to correspond to the first light sources f the first light source group and second light sources of the second light source group; and a light diffusion body that diffuses light incident through the light guide body. The first light sources comprise a center light source located between the second light sources and an end light source located at outside of the center light source located at both ends. A region of the light guide body located at a side of the first and second light sources includes: a first portion corresponding to the second light source; a second portion corresponding to the center light source of the first light sources; and a third portion include in the low light distribution region, being other than the first and second portions, and having a presence ratio of the light diffusion body greater than the presence ratio of the light diffusion body in the first portion. The quantity of light incident in the light guide body from the end light source is smaller than the quantity of light incident in the light guide body from the center light source.

In the light source device described above, the presence ratio of the light diffusion body in the third portion of the light guide body is greater than the presence ratio of the light diffusion body in the first portion of the light guide body. Therefore, in the light source device according to the invention, among the low light distribution region where a part of light emitted from the respective light sources of the second light source group are incident, brightness in the third portion where brightness tends to be lowered compared to the second portion, can be enhanced. On the other hand, in the light source device according to the invention, the quantity of light incident in the light guide body from the light source, among the light sources of the first light source group, which is arranged to be opposite to the third portion of the light guide body, is smaller than the quantity of light incident in the light guide body from the light source arranged to be opposite to the second portion of the light guide body. Therefore, the light source device according to the invention can prevent the brightness caused by the light from the respective light sources of the first light source group from being excessively increased in the third portion, even though the presence ratio of the light diffusion body in the third portion of the light guide body is relatively great.

Further, in the light source device according to the invention, the respective light sources of the second light source group are located between the light sources of the first light source group. Specifically, in the light source device according to the invention, it is unnecessary to arrange the respective light sources of the first light source group and the respective light sources of the second light source group in such a manner that they are overlapped with each other in a thickness direction of the light guide body. Accordingly, the light source device according to the invention can reduce the size of the light guide body in the thickness direction.

From the above, the light source device according to the invention can reduce brightness unevenness of the light emission based upon the light source groups, and can be downsized.

Since a display apparatus according to one embodiment of the invention includes the above-mentioned light source device, the effect of the light source device according to the invention can be obtained in the display apparatus. Specifically, the display apparatus according to the invention can reduce brightness unevenness of the light emission based upon the light source groups, and can be downsized.

### BRIEF DESCRIPTION OF DRAWINGS

FIG. 1A is a plan view illustrating a light source device according to a first embodiment of the invention.

FIG. 1B is a sectional view taken along a line Ib-Ib in FIG. 1A.

FIG. 2 is a graph illustrating one example of a relationship between a light distribution angle of a light source and a brightness.

FIG. 3A is a plan view illustrating the plurality of light sources and the light guide body illustrated in FIGS. 1A and 1B.

FIG. 3B is an enlarged plan view illustrating an essential part of the light sources and the light guide body illustrated in FIGS. 1A and 1B.

FIG. 4A is a plan view illustrating a light source device according to a second embodiment of the invention.

FIG. 4B is a sectional view taken along a line IVb-IVb.

FIG. 5A is a plan view illustrating the light sources and the light guide body illustrated in FIG. 4A.

FIG. 5B is an enlarged plan view illustrating an essential part of the light sources and the light guide body illustrated in FIG. 4A.

FIG. 6A is a plan view illustrating a light source device according to a third embodiment of the invention.

FIG. 6B is a sectional view taken along a line VIb-VIb in FIG. 6A.

FIG. 7A is a plan view illustrating the light sources and the light guide body illustrated in FIG. 6A.

FIG. 7B is an enlarged plan view illustrating an essential part of the light sources and the light guide body illustrated in FIG. 6A.

FIG. 8 is a sectional view illustrating a schematic configuration of a display apparatus provided with the light source device illustrated in FIG. 1.

FIG. 9 is a perspective view illustrating a schematic configuration of a liquid crystal display panel in the display apparatus illustrated in FIG. 8.

FIG. 10 is an enlarged sectional view illustrating an essential part of the liquid crystal display panel illustrated in FIG. 9.

FIG. 11A is a plan view illustrating a first modification of the light source device illustrated in FIG. 1.

FIG. 11B is an enlarged plan view illustrating an essential part of the first modification of the light source device illustrated in FIG. 1.

FIG. 12A is a plan view illustrating a second modification of the light source device illustrated in FIG. 1.

FIG. 12B is an enlarged plan view illustrating an essential part of the second modification of the light source device illustrated in FIG. 1.

### BEST MODES FOR CARRYING OUT THE INVENTION

Embodiments of a light source device and a display apparatus provided with such a light source device according to the invention will be described in detail with reference to the drawings. It is to be noted that the invention is not limited by the embodiments.

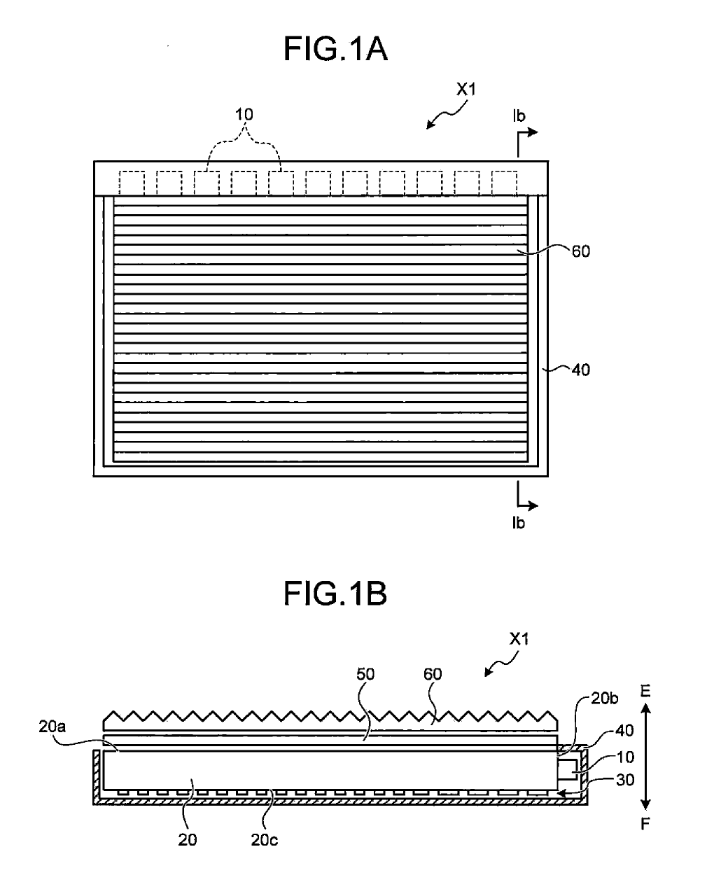

A light source device X1 according to a first embodiment of the invention will be described with reference to FIGS. 1A, 1B, 2, 3A and 3B.

As illustrated in FIGS. 1A and 1B, the light source device X1 includes a first light source group 10A, a second light source group 10B, a light guide body 20, a light diffusion body 30, a reflection body 40, a diffusion plate 50, and a prism 60. The light source device X1 guides light, which is emitted from a plurality of light sources 10 constituting the first light source group 10A and the second light source group 10B, to a subject to be irradiated (e.g., a liquid crystal display panel) through the light guide body 20.

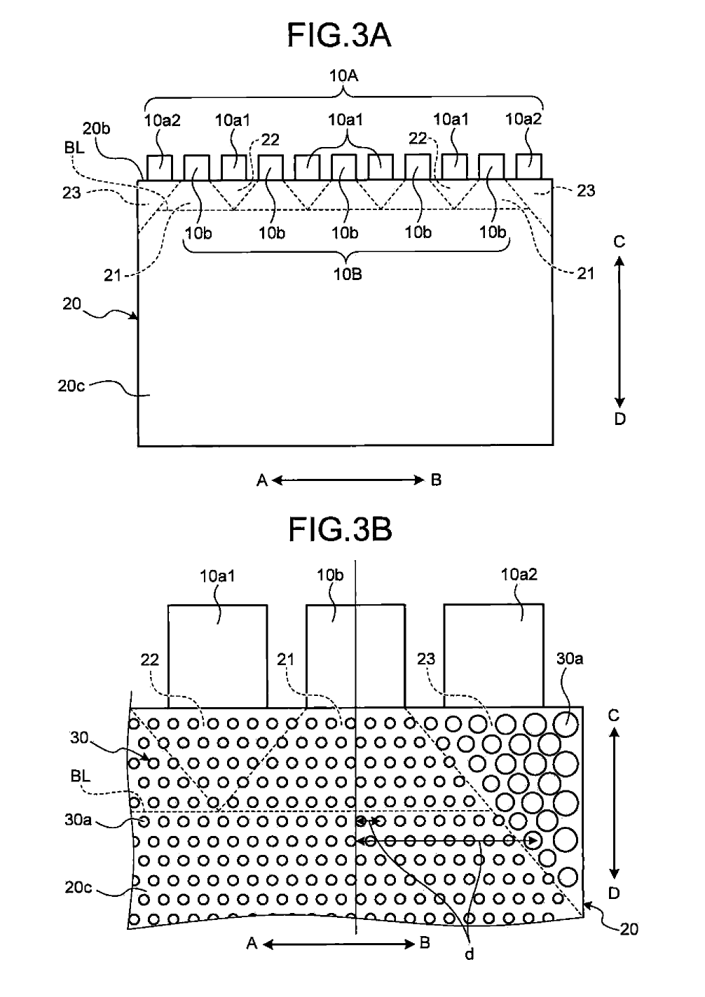

The first light source group 10A includes a plurality of light sources 10a (center light source 10a1 and end light source 10a2), while the second light source group 10B includes a plurality of second light sources 10b each located between the respective light sources 10a of the first light source group 10A. The first light source group 10A includes the center light source 10a1 located between the second light sources 10b and the end light source 10a2 located at the outside of the center light source 10a1 located at both ends. In the present embodiment, the light source device X1 includes four center light sources (first light source) 10a1, five second light sources 10b, and two end light sources (first light source) 10a2 as illustrated in FIGS. 3A and 3B. These light sources 10 are arranged in a direction indicated by an arrow AB. Examples of the light source 10 include Light Emitting Diode (LED), Cathode Fluorescent Lamp (CFL), halogen lamp, xenon lamp, and electro-luminescence (EL). The light source 10 is preferably an LED from the viewpoint of reduced power consumption and reduced noise.

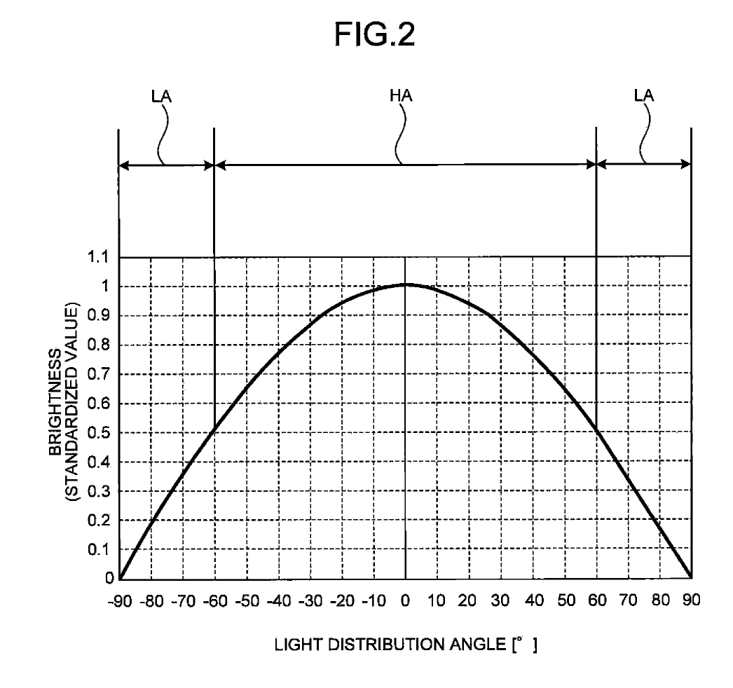

In the light source device X1, the angle at which the brightness of the light emitted from the respective second light sources 10b of the second light source group 10B is not less than a reference value is defined as a high light distribution angle, while the angle at which the brightness is less than the reference value is defined as a low light distribution angle. The reference value may be set to a desired value according to a required performance, but it is preferably set so as to enhance uniformity of the brightness on a light emitting surface 20a (see FIG. 1B) emitting light toward the subject to be irradiated. For example, when brightness of light incident on a light incidence surface 20b of the light guide body 20, on which light from the second light source 10b is incident, from the second light source 10b in a direction vertical to the light emitting surface 20a is defined as 1 (standardized), the reference value is preferably set to be 0.4 or more and 0.6 or less. When, for example, it is supposed that the relationship between the light distribution angle and the brightness of a light source is as illustrated by a graph in FIG. 2, the light source having the relationship illustrated in FIG. 2 is employed as the second light sources 10b, and the reference value is set to be 0.5 (standardized value), an distribution angle in the range within −60° to 60° corresponds to the high light distribution angle HA, while an distribution angle in the range within −90° to −60° and 60° to 90° corresponds to the low light distribution angle LA.

The light guide body 20 illustrated in FIGS. 1B, 3A, and 3B has a function of guiding the light emitted from the light sources 10 to the subject to be irradiated. The light guide body 20 has the light incidence surface 20b on which the light emitted from the light sources 10 is incident, and the light emitting surface 20a from which the light incident through the light incidence surface 20b is emitted to the subject to be irradiated. The light incidence surface 20b of the light guide body 20 is arranged so as to correspond to the plurality of light sources. For example, the light incidence surface 20b of the light guide body 20 is arranged so as to be opposite to the light sources 10. Examples of the material for the light guide body 20 include a material having light transparency, such as acrylic resin and polycarbonate resin.

In the light source device X1, a region in the light guide body 20 where the light emitted from the respective second light sources 10b of the second light source group 10B in the direction of the high light distribution angle is incident is defined as a high light distribution region, while a region that is other than the high light distribution region and on which the light emitted in the direction of the low light distribution angle is incident is defined as a low light distribution region. Therefore, in the light guide body 20, a plurality of the high light distribution regions and a plurality of the low light distribution regions for the respective second light sources 10b are defined. Specifically, in the light guide body 20, the high light distribution regions and low light distribution regions in number same as the number of the second light sources 10b are defined.

The light guide body 20 includes a first portion 21, a second portion 22, and a third portion 23 as illustrated in FIGS. 3A and 3B. In FIGS. 3A, 3B, the borderline of the respective portions 21, 22, and 23 is indicated by a broken line. A later-described reference line BL is also indicated by a broken line. The reference line BL is a straight line that links intersections of, among the borderlines each between one of the high light distribution regions and one of the low light distribution regions corresponding to one of the second light sources 10b of the second light source group 10B, the borderlines between the high light distribution regions and the low light distribution regions corresponding to adjacent ones of the second light sources 10b of the second light source group 10B.

The first portions 21 are a part of each of the above-mentioned high light distribution regions located closer to the respective second light sources 10b than the reference line BL. The second light sources 10b are arranged so as to correspond to the first portions 21, e.g., so as to be opposite to the first portions 21.

The second portion 22 corresponds to the low light distribution regions located between the first portions 21. Each of the center light sources 10a1 is arranged so as to correspond to each of the second portions 22, i.e., so as to be opposite to each of the second portions 22. The second portion 22 corresponds to the low light distribution regions in the light guide body 20 located at positions where the low light distribution regions of adjacent ones of the second light sources 10b of the second light source group 10B are overlapped with each other.

The third portion 23 corresponds to the low light distribution regions other than the second portion 22. The end light source 10a2 is arranged so as to correspond to the third portion 23, e.g., so as to be opposite to the third portion 23. The third portion 23 corresponds to the low light distribution regions in the light guide body 20 that is not overlapped with the low light distribution region of adjacent one of the second light sources 10b of the second light source group 10B in the low light distribution regions. For example, the third portion 23 corresponds to the low light distribution regions in the light guide body 20 located at the position close to the end portion of the light guide body 20 in the later-described array direction of the light sources 10 (in the AB direction in FIG. 3B).

In the present embodiment, the quantity of light incident in the light guide body 20 from the end light sources 10a2 is smaller than the quantity of light incident in the light guide body 20 from the center light sources 10a1 among the light sources 10a1 and 10a2 of the first light source group 10A. The maximum brightness of the end light source 10a2 is smaller than the maximum brightness of the center light source 10a1.

The light diffusion body 30 illustrated in FIG. 1B has a function of diffusing light incident through the light guide body 20. The presence ratio of the light diffusion body 30 at the third portion 23 is greater than the presence ratio at the first portion 21. The presence ratio of the light diffusion body 30 means the presence percentage of the light diffusion body 30 located at a predetermined region. Specifically, the presence ratio of the light diffusion body 30 at the first portion 21 is, for example, obtained by dividing the total sum of the areas in planar view of the light diffusion body 30 located at the first portion 21 by the total sum of the areas in planar view of the first portion 21.

The presence ratio of the light diffusion body 30 at the first portion 21 is preferably 5 or more and 5.0 or less. With this, uniformity of the brightness of the light emission based upon the second light sources 10b can be increased. The presence ratio of the light diffusion body 30 at the third portion 23 is preferably 15 or more and 90 or less. With this, uniformity of the brightness of the light emission based upon the first light sources 10a can be increased. The presence ratios of the light diffusion body 30 at the first portion 21, and at the third portion 23 are enough to have the inequality relation described above, and they are not limited to the above-mentioned values.

In the present embodiment, the light diffusion body 30 is located at a portion other than the light emitting surface 20a, which is a main light emitting surface of the light guide body 20. For example, the light diffusion body 30 is located on one surface (lower surface 20c) of the light guide body 20 corresponding to the light emitting surface 20a. The light diffusion body 30 is preferably whitish from the viewpoint of reducing the difference in the light diffusion property caused by the difference in color of incident light, but it is not limited thereto. Further, as illustrated in FIG. 3B, the light diffusion body 30 comprises a plurality of dot-shaped bodies 30a arranged in a predetermined pattern. In the present embodiment, a structure having a substantially circular shape as viewed in plane is employed for the dot-shaped body 30a.

The dot-shaped bodies 30a are arranged on the lower surface 20c along the array direction of the light sources 10 (in the AB direction in FIG. 3B) and along the direction crossing the array direction (in a CD direction in FIG. 3B).

In the present embodiment, the area in planar view of each of the dot-shaped bodies 30a located in the region on the lower surface 20c corresponding to the first portion 21 and the area in planar view of each of the dot-shaped bodies 30a located in the region corresponding to the second portion 22 are substantially equal. On the other hand, the dot-shaped bodies 30a located in the region corresponding to the third portion 23 are supposed to be classified into a plurality of sets such that the dot-shaped bodies 30a classified to the same one of the sets are located on the same one of rows arranged in the array direction (in the AB direction in FIG. 38). In this time, the area in planar view of each of the dot-shaped bodies 30a classified into each of the sets is larger as the separation distance d of the corresponding dot-shaped body 30a from the second light source 10b adjacent to the end light source 10a2 is larger.

The area in planar view of each of the dot-shaped bodies 30a is the area in planar view of the portion (specifically, the portion where each of the dot-shaped bodies 30a is in contact with the lower surface 20c) where each of the dot-shaped bodies 30a is in contact with the light guide body 20. The separation distance d of each of the dot-shaped bodies 30a is the distance in the array direction (in the AB direction in FIGS. 3A and 3B), and the shortest distance from the second light source 10b, which is located closest to one of the dot-shaped bodies 30a, to the one of the dot-shaped bodies 30a. Specifically, the separation distance d is the shortest distance from the second light source 10b, which is adjacent to the end light source 10a2, to the respective dot-shaped bodies 30a in the array direction (in the AB direction in FIGS. 3A and 3B).

The reflection body 40 illustrated in FIGS. 1A and 1B has a function of reflecting the light emitted from the portion of the light guide body 20 other than the light emitting surface 20a toward the light guide body 20. The reflection body 40 is mainly arranged so as to oppose to the lower surface 20c of the light guide body 20. The reflection body 40 also has a function of reflecting the light, which is not incident in the light guide body 20, among the light emitted from the light sources 10 toward the light guide body 20. A part of the reflection body 40 is provided to cover a part of the light sources 10. Examples of the reflection body 40 include a whitish foam obtained by extending a resin material such as polyethylene terephthalate (PET), the one containing a base including a resin material such as PET and silver formed on the base as a film, the one having a base containing a resin material such as PET and a dielectric film laminated onto the base, and the one obtained by forming or extending a resin material such as PET containing TiO₂.

The diffusion plate 50 illustrated in FIG. 1B has a function of enhancing uniformity in brightness of light emitted from the light emitting surface 20a of the light guide body 20 toward the subject to be irradiated. The diffusion plate 50 is mainly arranged so as to oppose to the light emitting surface 20a of the light guide body 20. Examples of the diffusion plate 50 includes a sheet having a base containing a resin material such as PET and a silica-beads-containing resin cured on the base, and a sheet obtained by mixing silica beads into a resin material such as polycarbonate (PC).

The prism 60 illustrated in FIGS. 1A and 1B has a function of refracting the incident light. The prism 60 refracts the light incident on the prism 60 to emit the refracted light in substantially vertical direction with respect to the light emitting surface 20a of the light guide body 20. Examples of the prism 60 include the one having a base containing a resin material such as PET and a prism structure formed from an acrylic material laminated onto the base, and the base containing a resin material such as PC, the base being processed to have a prism structure.

In the light source device X1 in the present embodiment, the presence ratio of the light diffusion body 30 at the third portion 23 of the light guide body 20 is greater than the presence ratio of the light diffusion body 30 at the first portion 21 of the light guide body 20. Therefore, in the light source device X1, in the low light distribution region on which a part of light emitted from the respective second light sources 10b of the second light source group 10B are incident, the brightness at the third portion 23, which tends to have a low brightness compared to the second portion 22, can be increased. On the other hand, in the light source device X1, the quantity of light incident in the light guide body 20 from the end light source 10a2 is smaller than the quantity of light incident in the light guide body 20 from the center light source 10a1. Therefore, the light source device X1 can prevent the brightness caused by light from the light sources 10a1 and 10a2 of the first light source group 10A from excessively increasing at the third portion 23, even though the presence ratio of the light diffusion body 30 at the third portion 23 of the light guide body 20 is relatively great.

In the light source device X1, each of the second light sources 10b of the second light source group 10B is located between the light sources 10a1 and 10a2 of the first light source group 10A. Specifically, in the light source device X1, the respective light sources 10a1 and 10a2 of the first light source group 10A and the respective second light sources 10b of the second light source group 10B are arranged at the same position in the thickness direction of the light guide body 20 (in an EF direction in FIG. 1B). Accordingly, in the light source device X1, it is unnecessary to arrange the respective light sources 10a1 and 10a2 of the first light source group 10A and the respective second light sources 10b of the second light source group 10B in such a manner that they are overlapped with each other in the thickness direction of the light guide body 20 (in the EF direction in FIG. 1B). Therefore, the size in the thickness direction of the light guide body 20 can be reduced in the light source device X1.

From the above, the light source device X1 can reduce brightness unevenness in the light emission based upon the light sources 10, and can be downsized.

In the light source device X1, the maximum brightness of the end light source 10a2 is smaller than the maximum brightness of the center light source 10a1. Specifically, in the light source device X1, the center light source 10a1 and the end light source 10a2 can serve to adjust the incident quantity of light incident in the light guide body 20 from the center light source 10a1 and the end light source 10a2.

In the light source device X1, the light diffusion body 30 is located at the region (lower surface 20c) other than the main light emitting surface 20a of the light guide body 20. Therefore, this allows the light diffusion body 30 to be difficult to be visually confirmed. Accordingly, the light source device X1 is particularly effective when it is applied as a light source for a display apparatus, such as a backlight for a liquid crystal display apparatus.

In the light source device X1, the dot-shaped bodies 30a are arranged along the array direction of the second light source group 10B (in the AB direction in FIG. 3B) and along the direction crossing the array direction (in CD direction in FIG. 3B). Thus, the ease of designing the light diffusion body 30 can be enhanced. When the dot-shaped bodies 30a located in the region corresponding to the third portions 23 are classified into a plurality of sets such that the dot-shaped bodies 30a classified into the same one of the sets is located on the same one of rows arranged in the array direction (in the AB direction in FIG. 3B), the area in planar view of each of the dot-shaped bodies 30a classified into each of the sets is larger as the separation distance d of the corresponding dot-shaped body 30a from the second light source 10b adjacent to the end light source 10a2 is larger. Therefore, the light source device X1 can reduce the brightness unevenness, while enhancing the ease of designing the light diffusion body 30.

The dot-shaped bodies 30a are also arranged at the region corresponding to the portion located in the high light distribution region at the reverse side of the first portion 21 with respect to the reference line BL in order that the arrangement of the dots and the area in planar view of the dot-shaped bodies are not greatly changed across the reference line BL.

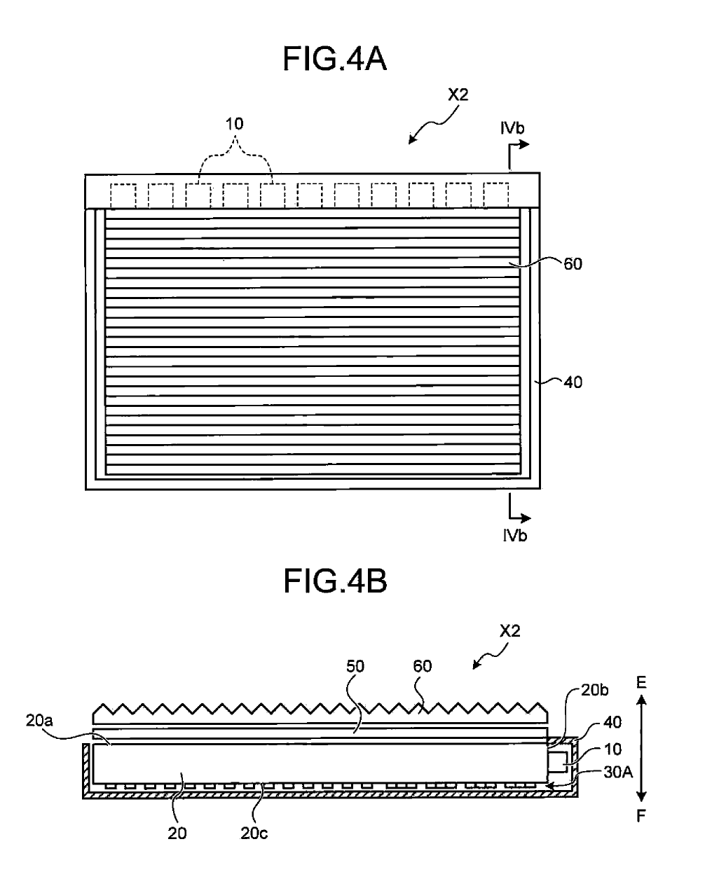

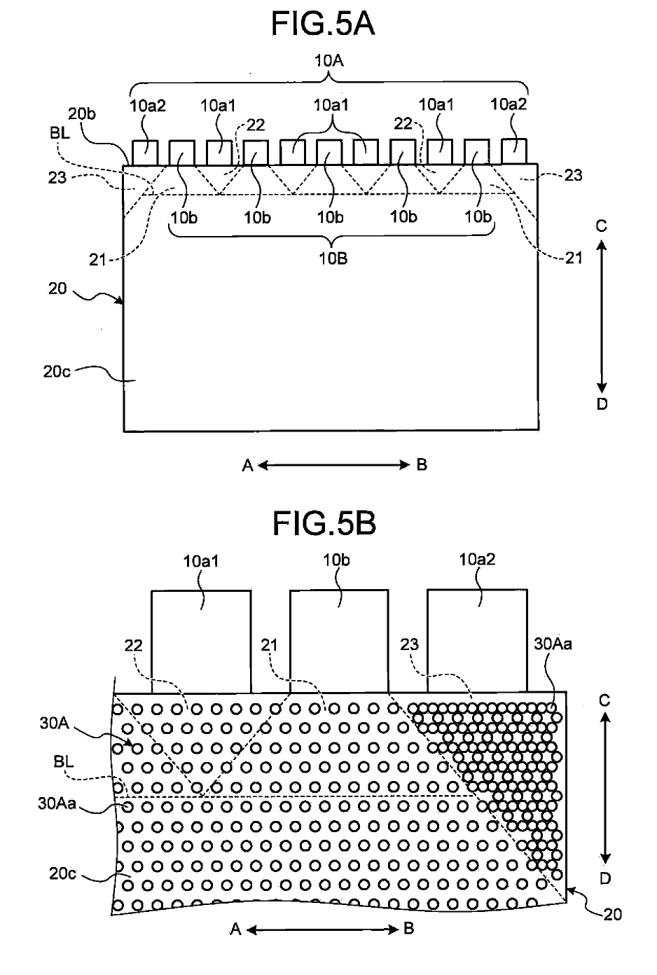

A light source device X2 according to a second embodiment of the invention will next be described with reference to FIGS. 4A, 4B, 5A, and 5B.

In FIG. 5A, the borderlines of the respective portions 21, 22, and 23 are indicated by a broken line. The light source device X2 is different from the light source device X1 in that the light source device X2 employs a light diffusion body 30A instead of the light diffusion body 30. The other configurations of the light source device X2 are the same as those of the light source device X1 described above.

The light diffusion body 30A illustrated in FIGS. 4B and 5B is different from the above-mentioned light diffusion body 30 in the arrangement on the light guide body 20.

In the present embodiment, the light diffusion body 30A is located on the lower surface 20c of the light guide body 20, like the above-mentioned light diffusion body 30 (30a). The light diffusion body 30A comprises a plurality of dot-shaped bodies 30Aa arranged in a predetermined pattern as illustrated in FIG. 5B. The dot-shaped bodies 30Aa are arranged along the array direction of the light sources 10 (in the AB direction in FIGS. 5A and 5B) and along the direction crossing the array direction (in the CD direction in FIGS. 5A and 5B).

In the present embodiment, different from the light diffusion body 30 (30a), the areas in planar view of the dot-shaped bodies 30Aa located in the region corresponding to the first portion 21, the region corresponding to the second portion 22, and the region corresponding to the third portion 23 (the area in planar view of the portion that is in contact with the light guide body 20) are substantially equal. The arrangement number of the dot-shaped bodies 30Aa located at the region corresponding to the third portion 23 is greater than the arrangement number of the dot-shaped bodies 30Aa located at the region corresponding to the first portion 21 or at the region corresponding to the second portion 22. Further, the dot-shaped bodies 30Aa located at the region corresponding to the third portion 23 are arranged substantially uniform on the entire surface of the region corresponding to the third portion 23. As illustrated in FIG. 5B, the dot-shaped bodies 30Aa are arranged in a honeycomb form as illustrated in FIG. 5B. The arrangement of the dot-shaped bodies 30Aa is not limited thereto. The dot-shaped bodies 3OAa may be arranged in a matrix form. The arrangement number of the dot-shaped bodies 30Aa described above means the number of the dot-shaped bodies 30Aa per a unit area in the region.

In the light source device X2 according to the present embodiment, since the dot-shaped bodies 30Aa are arranged as described above, the presence ratio of the light diffusion body 30A at the third portion 23 of the light guide body 20 is greater than the presence ratio of the light diffusion body 30A at the first portion 21 of the light guide body 20. Therefore, in the light source device X2, in the low light distribution region on which a part of light emitted from the respective second light sources 10b of the second light source group 10B are incident, the brightness in the third portion 23, which tends to have a low brightness compared to the second portion 22, can be increased. On the other hand, in the light source device X2, the quantity of light incident in the light guide body 20 from the end light source 10a2 is smaller than the quantity of light incident in the light guide body 20 from the center light source 10a1. Therefore, the light source device X2 can prevent the brightness of light caused by the respective light sources 10a1 and 10a2 of the first light source group 10A from excessively increasing at the third portion 23, even though the presence ratio of the light diffusion body 30 at the third portion 23 of the light guide body 20 is relatively great. As a result, the light source device X2 can also reduce the brightness unevenness in the light emission based upon the light sources 10. Further, since the areas in planar view of the dot-shaped bodies 3OAa are substantially equal in the light source device X2, the ease of designing the light diffusion body 30A is further enhanced.

As described above, in the light source device X2, the areas in planar view of the dot-shaped bodies 30Aa located at the regions corresponding to the first portion 21, the second portion 22, and the third portion 23 are substantially equal. Therefore, the ease of designing the light diffusion body 30A can further be enhanced.

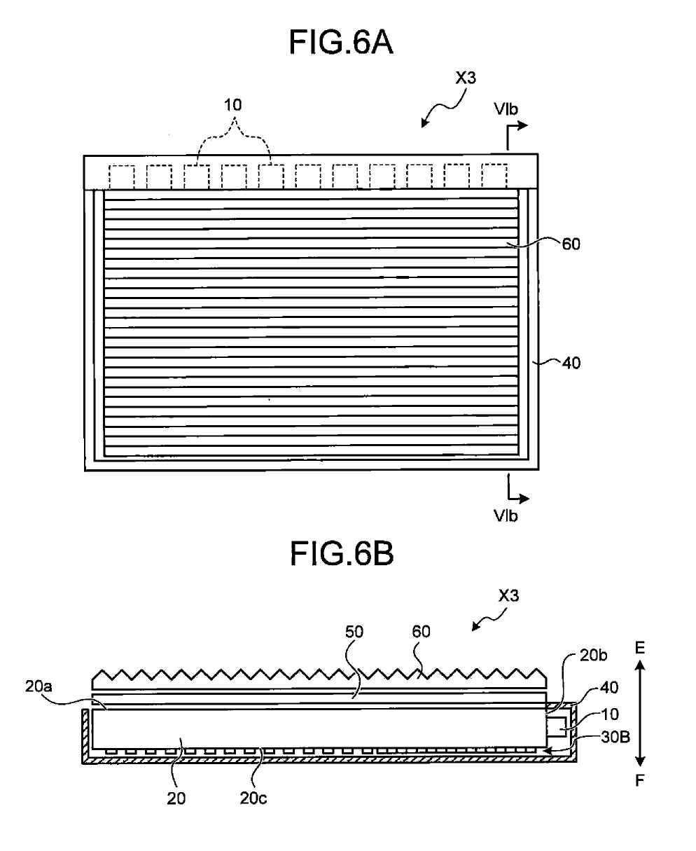

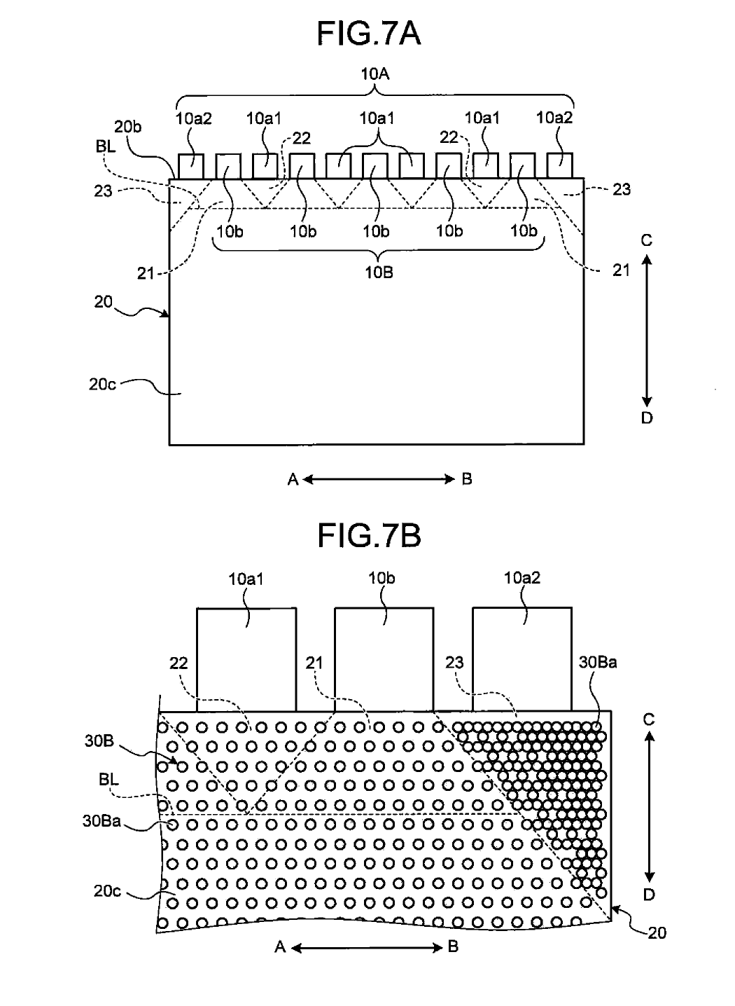

A light source device X3 according to a third embodiment of the invention will next be described with reference to FIGS. 6A, 6B, 7A, and 7B.

In FIG. 7, the borderline of the respective portions 21, 22, and 23 is indicated by a broken line. The light source device X3 is different from the light source device X2 in that the light source device X3 employs a light diffusion body 30B instead of the light diffusion body 30A. The other configurations of the light source device X3 are the same as those of the light source device X2 described above.

The light diffusion body 30B illustrated in FIGS. 6B and 7B is different from the above-mentioned light diffusion body 30A in the arrangement on the light guide body 20.

In the present embodiment, the light diffusion body 30B is located on the lower surface 20c of the light guide body 20, like the above-mentioned light diffusion body 30A (see FIGS. 6B and 7B). The light diffusion body 30B comprises a plurality of dot-shaped bodies 30Ba arranged in a predetermined pattern as illustrated in FIG. 7B.

The dot-shaped bodies 30Ba are arranged along the array direction of the light sources 10 (in the AB direction in FIG. 7A) and along the direction crossing the array direction (in the CD direction in FIG. 7B). The areas in planar view of the dot-shaped bodies 30Ba located in the region corresponding to the first portion 21, in the region corresponding to the second portion 22, and in the region corresponding to the third portion 23 (the areas in planar view of the portions that are in contact with the light guide body 20) are substantially equal.

In the present embodiment, different from the light diffusion body 30A, the arrangement number of the dot-shaped bodies 30Ba located at the region corresponding to the third portion 23 is greater than the arrangement number of the dot-shaped bodies 30Ba located at the region corresponding to the first portion 21 or at the region corresponding to the second portion 22. Further, the arrangement number of the dot-shaped bodies 30Ba located at the region corresponding to the third portion 23 is larger at the portion where the quantity of light from the respective second light sources 10b of the second light source group 10B tends to be smaller. Specifically, the presence ratio of the dot-shaped bodies 30Ba located at the region corresponding to the third portion 23 is larger in the portion having the greater distance from the second light source 10b of the second light source group 10B located closest to the third portion 23.

In the present embodiment, the dot-shaped bodies 30Ba are arranged in a honeycomb form as illustrated in FIG. 7B. With this structure, the dot-shaped bodies 30Ba are efficiently arranged in order that the presence ratio of the dot-shaped bodies 30Ba is great at the above-mentioned region.

Since the light source device X3 according to the present embodiment has the above-mentioned arrangement of the dot-shaped bodies 30Ba, it can provide the effect same as that of the light source device X2. Further, in the light source device X3, the arrangement number of the dot-shaped bodies 30Ba located at the region corresponding to the third portion 23 is larger at the portion where the quantity of light from the second light sources 10b of the second light source group 10B tends to be smaller. Therefore, the light source device X3 can further reduce the brightness unevenness, while enhancing the ease of designing the light diffusion body 30B. Specifically, the effect of reducing the brightness unevenness is enhanced.

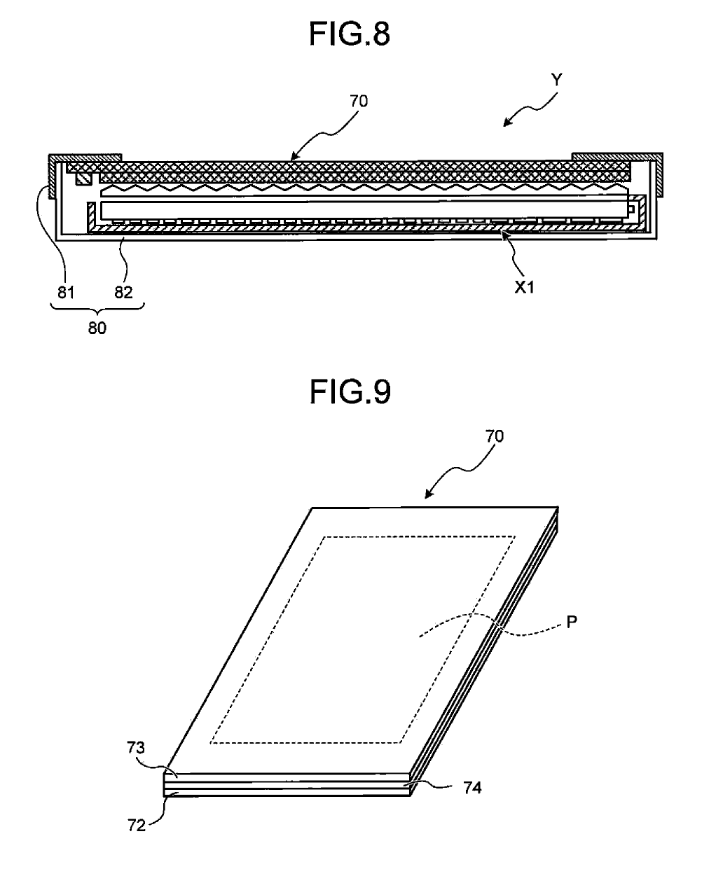

A display apparatus Y according to the embodiment of the invention will next be described with reference to FIGS. 8 to 10. The display apparatus Y has the light source device X1, a liquid crystal display panel 70, and a housing 80. The housing 80 accommodates the liquid crystal display panel 70 and the light source device X1, and includes an upper housing 81 and a lower housing 82. Examples of the material constituting the housing 80 include a resin such as polycarbonate resin, and a metal such as a stainless (SUS) or aluminum. The display apparatus Y has the light source device X1. However, the light source devices X2 and X3 may similarly be employed.

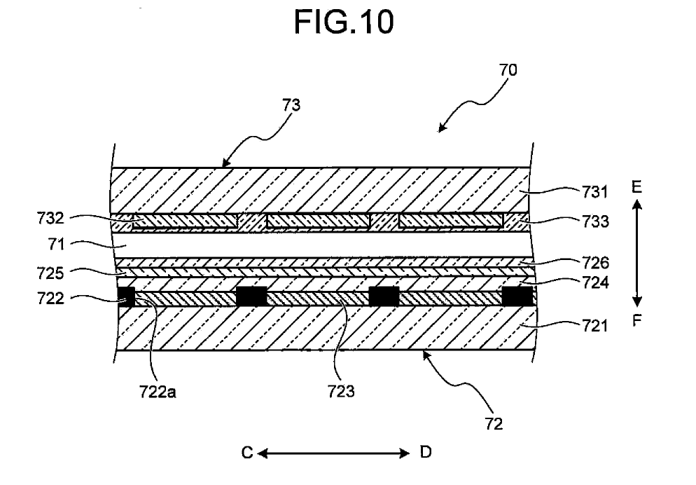

As illustrated in FIGS. 9 and 10, the liquid crystal display panel 70 includes a liquid crystal layer 71, a first base 72, a second base 73, and a sealing member 74. The liquid crystal layer 71 is located between the first base 72 and the second base 73, and is sealed by the sealing member 74. The liquid crystal display panel 70 thus configured has a display region P including a plurality of pixels for displaying an image.

The liquid crystal layer 71 contains liquid crystal that exhibits electrical, optical, mechanical, or magnetic anisotropy, and has both regularity of solid and fluidity of liquid. Examples of the liquid crystal include nematic liquid crystal, cholesteric liquid crystal, or smectic liquid crystal. The liquid crystal layer 71 may have a spacer (not illustrated) made of a great number of granular members in order to keep the thickness of the liquid crystal layer 71 constant.

The first base 72 includes a transparent base 721, a light-shielding film 722, a color filter 723, a flattening film 724, a transparent electrode 725, and an alignment film 726.

The transparent base 721 has a function of supporting the light-shielding film 722 and the color filter 723 and sealing the liquid crystal layer 71. The transparent base 721 suitably transmits light in the direction crossing the major surface thereof (e.g., in EF direction). Examples of the material of the transparent base 721 includes a glass or and light-transparent plastic.

The light-shielding film 722 has a function of shielding light (function of setting a transmitted amount of light to be not more than a predetermined value). It is formed on the upper surface of the transparent base 721. The light-shielding film 722 has through-holes 722a extending in the thickness direction (in the EF direction) in order to transmit light. Examples of the material for the light-shielding film 722 include a dye or pigment with a color having high light-shielding property (e.g., black), a resin (e.g., acrylic resin) to which carbon is added, chrome (Cr), and chrome oxide.

The color filter 723 is formed by adding a dye or pigment to a member (e.g., acrylic resin) that selectively absorbs a predetermined wavelength and selectively transmits only a predetermined wavelength among the light incident on the color filter 723. Examples of the color filter 723 include a red color filter (R) that selectively transmits wavelength of red visible light, a green color filter (G) that selectively transmits wavelength of green visible light, and a blue color filter (B) that selectively transmits wavelength of blue visible light.

The flattening film 724 has a function of flattening irregularities produced by the arrangement of the color filter 723, etc. A transparent resin such as acrylic resin is used as the material for the flattening film 724.

The transparent electrode 725 has a function of applying a predetermined voltage to the liquid crystal in the liquid crystal layer 71 located between the transparent electrode 725 and a transparent electrode 732 of the second base 73 later-described. The transparent electrode 725 transmits light incident from one side toward the other side. The transparent electrode 725 also has a function of propagating a predetermined signal (image signal). The plurality of transparent electrodes 725 are arranged so as to mainly extend in the CD direction. A conductive member having light transparency such as Indium Tin Oxide (ITO) or tin oxide may be used for the material of the transparent electrode 725.

The alignment film 726 has a function of aligning the liquid crystal molecules in the liquid crystal layer 71 in a predetermined direction. It is formed on the transparent electrode 725. Examples of the material for the alignment film 726 include a polyimide resin.

The second base 73 has a transparent base 731, a transparent electrode 732, and an alignment film 733.

The transparent base 731 has a function of supporting the transparent electrode 732 and the alignment film 733, and sealing the liquid crystal layer 71. The transparent base 731 suitably transmits light in the direction crossing the major surface thereof (e.g., in the EF direction). The same material for the transparent base 721 can be used for the material of the transparent base 731.

The transparent electrode 732 has a function of applying a predetermined voltage to the liquid crystal in the liquid crystal layer 71 located between the transparent electrode 732 and the transparent electrode 725 of the first base 72. The transparent electrode 732 transmits light incident from one side toward the other side. The transparent electrode 732 has a function of propagating a signal (scanning signal) that controls a voltage-applied state (ON) or voltage-non-applied state (OFF) to the liquid crystal layer 71. The plurality of transparent electrodes 732 are arranged so as to mainly extend in a direction perpendicular to the sheet surface in FIG. 9. The same material for the transparent electrode 725 can be used for the material of the transparent electrode 732.

The alignment film 733 has a function of aligning the liquid crystal molecules in the liquid crystal layer 71, which macroscopically face in the random direction (which have a small regularity). The alignment film 733 is formed on the transparent electrode 732. The same material for the alignment film 726 can be used for the material of the alignment film 726.

The sealing member 74 has a function of sealing the liquid crystal layer 71 between the first base 72 and the second base 73, and bonding the first base 72 and the second base 73 with the separated state from each other by a predetermined space. Examples of the sealing member 74 include an insulating resin and a sealing resin.

The light source device X1 is arranged so as to emit light toward the first base 72 of the liquid crystal display panel 70 from the light guide body 20.

Since the display apparatus Y according to the present embodiment has the light source device X1, the effect same as that of the light source device X1 can be obtained. Specifically, the display apparatus Y can reduce the brightness unevenness of the light emission based upon the light sources 10, and can be downsized.

Since the display apparatus Y can reduce the brightness unevenness by the light source device X1, the liquid crystal display panel 70 does not need to have the characteristic structure in which the light transmittance and an aperture ratio are changed at a part, but may have the simple structure in which the light transmittance and an aperture ratio are substantially uniform. Therefore, the display apparatus Y has high reliability with reduced cost.

The specific embodiments are described above, but the invention is not limited thereto. Various modifications are possible without departing from the scope of the invention.

In the present embodiment, the light source device X has the configuration in which light sources 10 constituting the first light source group 10A and the second light source group 10B are not overlapped with one another. However, the light source device X may have the configuration in which some of the light sources 10 are overlapped with one another.

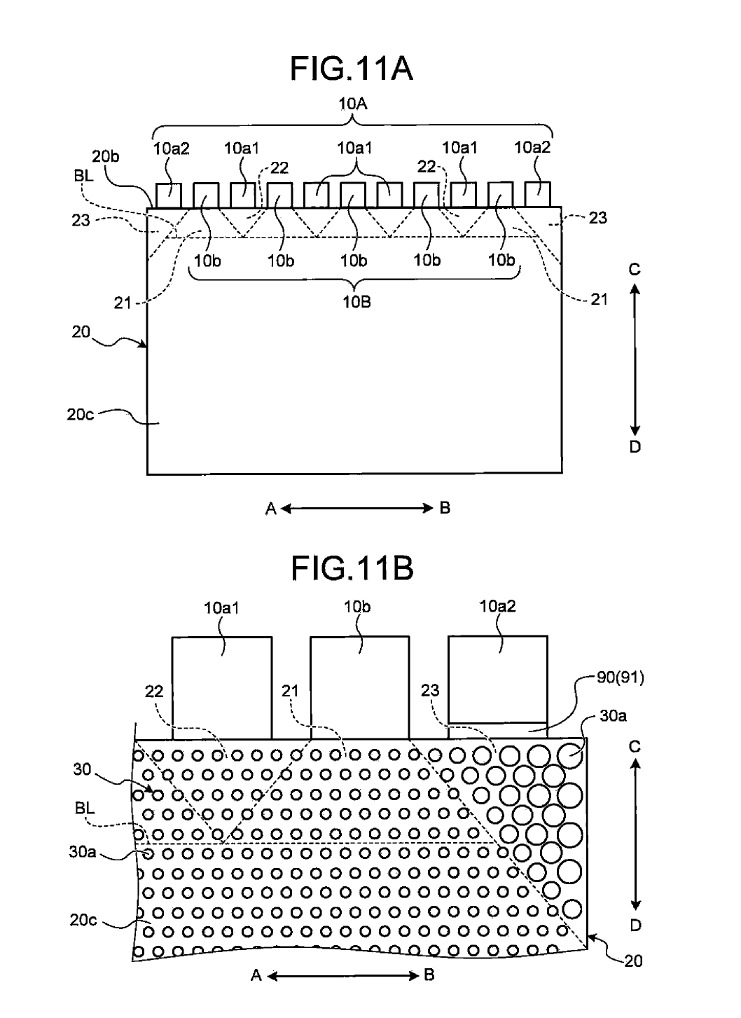

The light source devices X1, X2, and X3 have the structure in which the maximum brightness of the center light source 10a1 and the maximum brightness of the end light source 10a2 are different from each other, as the structure for reducing the quantity of light incident in the light guide body 20 from the end light source 10a2 compared with the quantity of light incident in the light guide body 20 from the center light source 10a1. However, the invention is not limited thereto. For example, as illustrated in FIGS. 11A and 11B, a semi-transmissive film 90 or a light diffusion film 91 may be provided between the light source, which is arranged to correspond to the third portion 23 of the light guide body 20, of the light sources constituting the first light source group, and the third portion 23. In this time, the first light source group may be constituted of one type of light sources, each having substantially equal maximum brightness.

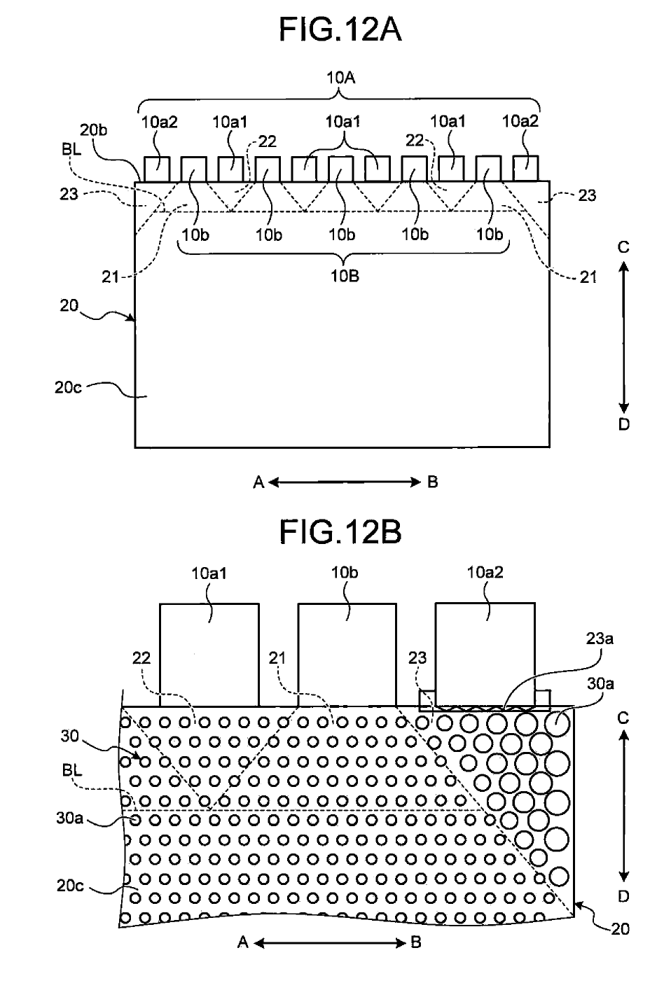

As illustrated in FIGS. 12A and 12B, the opposing surface of the light guide body 20 at the third portion 23, which is opposite to the first light source group, may be processed to diffuse light (an irregularity 23a is formed in FIG. 12B), as the structure of reducing the quantity of light incident in the light guide body 20 from the end light source 10a2 compared with the quantity of light incident in the light guide body 20 from the center light source 10a1. In this case too, the first light source group may be configured by one type of light sources, each having substantially equal maximum brightness.

With these configurations, the incidence amount into the light guide body from the respective light sources can be adjusted without adjusting the brightness of the respective light sources constituting the first light source group. Therefore, it is unnecessary to provide a control circuit for adjusting the incidence amount, whereby a driving circuit for each light source can be simplified.

As the configuration of emitting light from the light emitting surface 20a, the light source devices X1, X2, and X3 employ the structure of emitting light by the reflection in the light guide body 20, or by the reflection with the light diffusion bodies 30, 30A, and 30B and the reflection body 40. However, the invention is not limited thereto. For example, the thickness of the light guide body 20 may be changed, and particles may be distributed in the light guide body 20. For example, the configuration in which the thickness of the light guide body 20 is smaller at a part, the distance of which from the light sources 10 is larger, may be employed. With this configuration, the usage efficiency of light can be increased. In the configuration in which the particles are distributed in the light guide body 20, brightness can more be enhanced, if particles are distributed in the light guide body 20 to give haze of 3% or more and 5% or less.

In the light source devices X1, X2, and X3, the light guide body 20 and the light diffusion body 30, 30A, or 30B are separate structures. However, the invention is not limited thereto. For example, the light guide body 20 and the light diffusion bodies 30, 30A, and 30B may be an integral structure in which the light diffusion bodies 30, 30A, and 30B are made of the material same as the light guide body 20.

In the light source devices. X1, X2, and X3, the light diffusion bodies 30, 30A, and 30B are located on the lower surface 20c of the light guide body 20. However, they may be located at the side face of the light guide body 20, or provided in the light guide body 20.

The dot-shaped bodies 30a, 30aA, and 30Ba in the light source devices X1, X2, and X3 have a substantially cylindrical shape with a substantially circular shape in planar view from the viewpoint of enhancing ease of producing the light diffusion body 30A. However, the invention is not limited thereto. For example, the dot-shaped bodies 30a, 30Aa, and 30Ba may have a substantially semispherical shape with a substantial circular shape in planar view, or may have a substantially columnar shape with a substantially regular polygon shape in planar view.

In the light source devices X1, X2, and X3, the presence ratio of the light diffusion body 30 in the first portion 21 and the presence ratio of the light diffusion body 30 in the second portion 22 are substantially equal to each other. However, the invention is not limited thereto. For example, the presence ratio of the light diffusion body 30 in the second portion 22 may be greater than the presence ratio of the light diffusion body 30 in the first portion 21. With this configuration, the brightness unevenness of the light emission based upon the respective second light sources 10b constituting the second light source group 10B can more be reduced.

### EXPLANATIONS OF LETTERS OR NUMERALS

X1, X2, X3 Light source device

Y Display apparatus

BL Reference line

10 Light source

10a1 Center light source

10a2 End light source

10b Second light source

10A First light source group

10B Second light source group

20 Light guide body

21 First portion

22 Second portion

23 Third portion

30, 30A, 30B Light diffusion body

30a, 30Aa, 30Ba Dot-shaped body

40 Reflection body

50 Diffusion plate

60 Prism

70 Liquid crystal panel

80 Housing

90 Semi-transmissive film

91 Light diffusion film

1. A light source device comprising:
a first light source group comprising a plurality of first light sources;
a second light source group comprising a plurality of second light sources, each of which is located between the first light sources of the first light source group;
a light guide body arranged so as to correspond to the first light sources of the first light source group and second light sources of the second light source group; and
a light diffusion body that diffuses light incident through the light guide body, wherein
when a range of an angle where brightness of light emitted from the respective second light sources is not less than a reference value is defined as a high light distribution angle range of the respective second light sources, and a range of an angle where the brightness of light emitted from the respective second light sources is smaller than the reference value is defined as a low light distribution angle range of the second light sources, when, in the light guide body, a region where light emitted from the respective second light sources with an angle within the high light distribution angle range is incident is defined as a high light distribution region of the respective second light sources, and a region other than the high light distribution region and where light emitted from the respective second light sources with an angle within the low light distribution angle range is incident is defined as a low light distribution region of the respective second light sources, and when a border between the high light distribution region and the low light distribution region of each of the second light sources is defined as a borderline, and a line linking the intersections of the borderlines by the adjacent second light sources is defined as a reference line, the light guide body includes:
a plurality of first portions contained in the high light distribution region and located at a side close to the second light source than the reference line;
a second portion contained in the low light distribution region and located between the first portions; and
a third portion contained in the low light distribution region, being other than the first and second portions, and having a presence ratio of the light diffusion body greater than the presence ratio of the light diffusion body in the first portion, wherein
each of the first light sources is arranged so as to correspond to the second and the third portions of the light guide body, and the quantity of light incident in the light guide body from the first light source arranged so as to correspond to the third portion is smaller than the quantity of light incident in the light guide body from the first light source arranged so as to correspond to the second portion of the light guide body.

2. The light source device according to claim 1, wherein, among the light sources of the first light source group, the first light source arranged so as to correspond to the third portion of the light guide body has the maximum brightness smaller than the maximum brightness of the first light source arranged so as to correspond to the second portion of the light guide body.

3. The light source device according to claim 1, further comprising a semi-transmissive film between the third portion of the light guide body and the first light source arranged so as to correspond to the third portion.

4. The light source device according to claim 1, further comprising a light diffusion structure film between the third portion of the light guide body and the first light source arranged so as to correspond to the third portion.

5. The light source device according to claim 1, wherein the light diffusion body is located on a region other than a main light emitting surface of the light guide body.

6. The light source device according to claim 1, wherein the light diffusion body comprises a plurality of dot-shaped bodies, wherein
the dot-shaped bodies are arranged in a first direction that is along the second light source group and in a second direction crossing the first direction.

7. The light source device according to claim 6, wherein the area in planar view of each of the dot-shaped bodies, among the dot-shaped bodies at the third portion, constituting each of dot-shaped body groups each located on each of rows arranged in the first direction, is set so as to be larger as a separation distance of the corresponding dot-shaped body group from a light source among the second light sources, which light source is adjacent to the light source arranged to correspond to the third portion of the light guide body, is larger.

8. The light source device according to claim 1, wherein the shape of the light diffusion body is substantially cylindrical.

9. The light source device according to claim 1, wherein the light diffusion body is whitish.

10. The light source device according to claim 1, wherein the light guide body is arranged so as to face to the respective light sources of the first light source group and the second light source group.

11. A display apparatus comprising a light source comprising:
a first light source group comprising a plurality of first light sources;
a second light source group comprising a plurality of second light sources, each of which is located between the first light sources of the first light source group;
a light guide body arranged so as to correspond to the first light sources of the first light source group and second light sources of the second light source group; and
a light diffusion body that diffuses light incident through the light guide body, wherein
when a range of an angle where brightness of light emitted from the respective second light sources is not less than a reference value is defined as a high light distribution angle range of the respective second light sources, and a range of an angle where the brightness of light emitted from the respective second light sources is smaller than the reference value is defined as a low light distribution angle range of the second light sources, when, in the light guide body, a region where light emitted from the respective second light sources with an angle within the high light distribution angle range is incident is defined as a high light distribution region of the respective second light sources, and a region other than the high light distribution region and where light emitted from the respective second light sources with an angle within the low light distribution angle range is incident is defined as a low light distribution region of the respective second light sources, and when a border between the high light distribution region and the low light distribution region of each of the second light sources is defined as a borderline, and a line linking the intersections of the borderlines by the adjacent second light sources is defined as a reference line, the light guide body includes:
a plurality of first portions contained in the high light distribution region and located at a side close to the second light source than the reference line;
a second portion contained in the low light distribution region and located between the first portions; and
a third portion contained in the low light distribution region, being other than the first and second portions, and having a presence ratio of the light diffusion body greater than the presence ratio of the light diffusion body in the first portion, wherein
each of the first light sources is arranged so as to correspond to the second and the third portions of the light guide body, and the quantity of light incident in the light guide body from the first light source arranged so as to correspond to the third portion is smaller than the quantity of light incident in the light guide body from the first light source arranged so as to correspond to the second portion of the light guide body.

12. A light source device comprising:
a first light source group comprising the first light sources;
a second light source group comprising the second light sources, each of which is located between the first light sources of the first light source group;
a light guide body arranged so as to correspond to the first light sources of the first light source group and second light sources of the second light source group; and
a light diffusion body that diffuses light incident through the light guide body, wherein
the first light sources comprise a center light source located between the second light sources and an end light source located at outside of the center light source located at both ends,
a region of the light guide body located at a side of the first and second light sources includes:
a first portion corresponding to the second light source;
a second portion corresponding to the center light source of the first light sources; and
a third portion include in the low light distribution region, being other than the first and second portions, and having a presence ratio of the light diffusion body greater than the presence ratio of the light diffusion body in the first portion, and
the quantity of light incident in the light guide body from the end light source is smaller than the quantity of light incident in the light guide body from the center light source.
